(19) United States
(12) Patent Application Publication
(10) Pub. No.: US 2012/0043099 A1
(43) Pub. Date: Feb. 23, 2012

(54) SAFETY CYLINDER

(76) Inventor: CHI-LUNG CHOU, TAINAN CITY (TW)

(21) Appl. No.: 12/860,104

(22) Filed: Aug. 20, 2010

(51) Int. Cl. A62C 13/76

(52) U.S. Cl. 169/89

(57) ABSTRACT

A safety cylinder is revealed. The safety cylinder includes a cylinder having a bottle-top disposed with a circular flange and a threaded sleeve threaded with the bottle-top. An inner clip and a corresponding outer clip for holding and covering the circular flange of the bottle-top are disposed around a bottom side of the sleeve body so as to form an integrated and leak-proof cylinder. The cylinder is made from metal with thinner thickness and better hardness while the bottle-top is connected to the threaded sleeve with a certain thickness for turn threads. Thus the safety cylinder with high pressure-bearing and low manufacturing cost is obtained.

### BACKGROUND OF THE INVENTION

1. Fields of the Invention

The present invention relates to a safety cylinder, especially to a safety cylinder in which a cylinder of the safety cylinder is made from metal with thinner thickness and better hardness while a bottle-top of the cylinder is connected to a threaded sleeve with a certain thickness for turn threads so as to have high pressure-bearing and low manufacturing cost.

2. Descriptions of Related Art

A fire is one of the most devastating disasters. During a fire, people's lives and property are damaged and lost. The fire is unpredictable and a quick action is necessary to reduce the severity of the fire when a fire occurs. Fire extinguishers are first aid devices. Keep fire extinguishers in plain sight so that they can fight fires and put the fire out immediately in case of emergency.

Fire extinguishers are divided into different categories, according to the type of fire they are designed to eliminate. No matter what kind of category they belong to, the basic structure includes a cylinder, a nozzle, extinguishing agents and high pressure gas. Refer to prior art, a portable simple-type extinguisher can be carried or set in vehicles. The simple-type extinguisher mainly consists of a plastic cylinder filled with extinguishing agents and high pressure gas therein. A nozzle is arranged at a top of the cylinder. When a fire burns, release the safety device and squeeze the handle. The high pressure gas forces the extinguishing agent out of the nozzle to aim at the fire and put out the fire. During fire extinction, gas at a high pressure such as compressed carbon dioxide or nitrogen gas is not only used as a propellant but also used to shut off the air so as to stop the fire.

Thus the high pressure air plays an important role in the fire extinguisher. In order to hold the high pressure gas and prevent the breakage of the cylinder, the cylinder wall made from plastic materials is thickened to reinforce the cylinder wall against internal pressure. Although the thickened cylinder wall can bear the pressure and mount extinguishing agents as well as gas therein, the thickened cylinder wall results in increased manufacturing cost. Moreover, the wall thickness affects the success of the injection molding parts. The products having thick walls are with a high defect rate. Both raise the cost.

In order to overcome the shortcomings of the plastic cylinder available now such as the high manufacturing cost and the high defect rate during manufacturing processes, a novel design of a gas cylinder with higher safety by improvement of the simple-type extinguisher available now is provided.

### SUMMARY OF THE INVENTION

Therefore it is a primary object of the present invention to provide a safety cylinder with high pressure-bearing and low manufacturing cost.

In order to achieve above object, a safety cylinder of the present invention includes a cylinder with a bottle-top assembled with a threaded sleeve. The bottle-top of the cylinder is arranged with a circular flange. The threaded sleeve consists of an assembly hole penetrating a sleeve body along a center of the sleeve body, and a threaded segment formed on an outer wall of the sleeve body. An inner clip and an outer clip, corresponding to each other, are arranged around a bottom side of the sleeve body while a clip space for holding and covering the circular flange on the bottle-top of the cylinder is formed between the inner and the outer clips.

Moreover, the cylinder is made from metal with thinner thickness and better hardness and the bottle-top of the cylinder is connected to a threaded sleeve with a certain thickness for turn threads so as to obtain the safety cylinder with high pressure-bearing and low manufacturing cost.

Furthermore, the connection between the threaded sleeve and the cylinder is arranged with an inner clip and an outer clip, both holding and covering a circular flange on the bottle-top of the cylinder tightly. A washer is mounted in a gap between the threaded sleeve and the bottle-top of the cylinder. Thus the safety cylinder is like an integrated piece with leak proof feature.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an explosive view of an embodiment according to the present invention;

FIG. 2 is a cross sectional view of an embodiment in which a cylinder and a threaded sleeve are assembled with each other according to the present invention;

FIG. 3 is another cross sectional view of an embodiment in which a cylinder and a threaded sleeve are assembled with each other according to the present invention;

FIG. 4 is a cross sectional view of an assembled embodiment according to the present invention.

### DETAILED DESCRIPTION OF THE PREFERRED EMBODIMENT

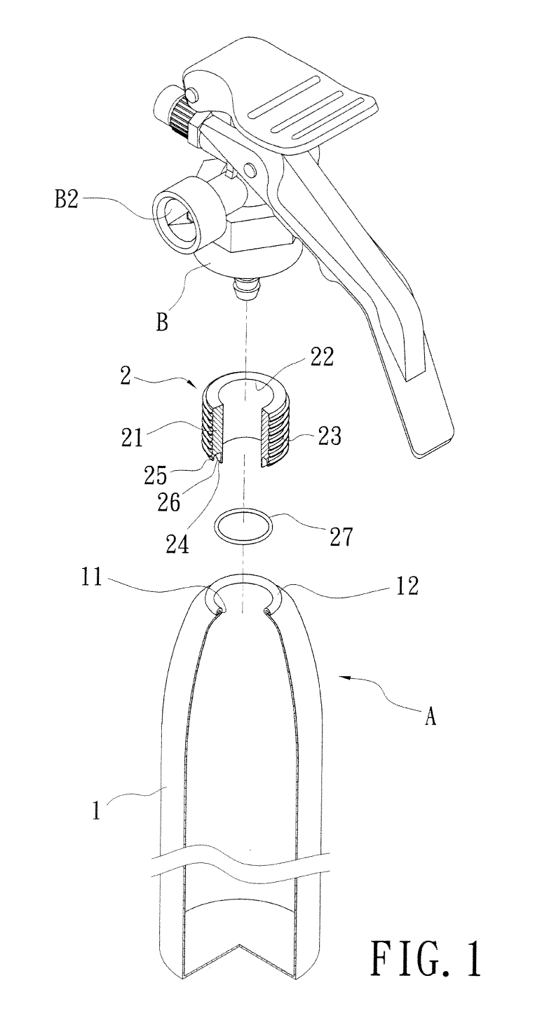

Refer to FIG. 1, a safety cylinder (A) according to the present invention mainly includes a cylinder 1 made from metal film and having a bottle-top 11 that is assembled with a threaded sleeve 2.

The bottle-top 11 of the cylinder 1 is disposed with a circular flange 12.

The threaded sleeve 2 is a tubular piece made from metal with a wall thicker than that of the cylinder 1. The threaded sleeve 2 consists of a sleeve body 21, an assembly hole 22 penetrating the sleeve body 21 along a center of the sleeve body 21, and a threaded segment 23 formed on an outer wall of the sleeve body 21. Moreover, an inner clip 24 and an outer clip 25, corresponding to each other, are arranged around a bottom side of the sleeve body 21. A clip space 26 is formed between the inner and the outer clips 24, 25 while a washer 27 is mounted in the clip space 26. The vertical length of the inner clip 24 is longer than that of the outer clip 25.

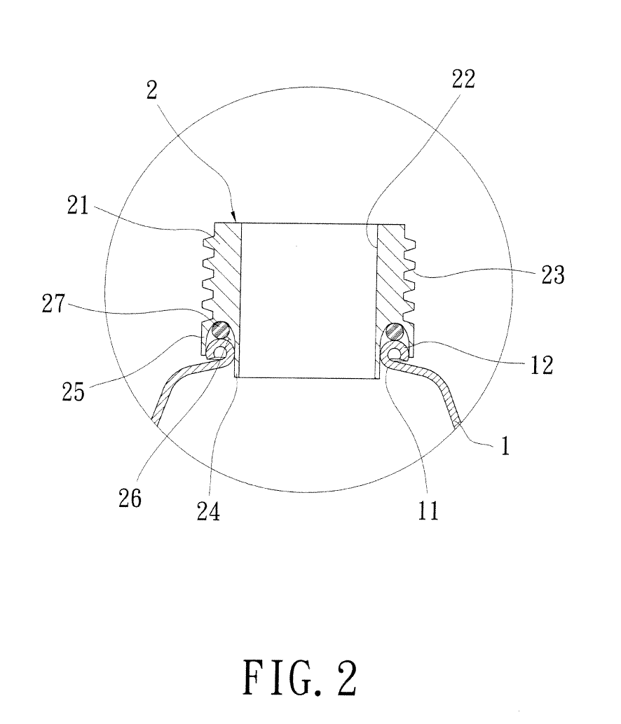

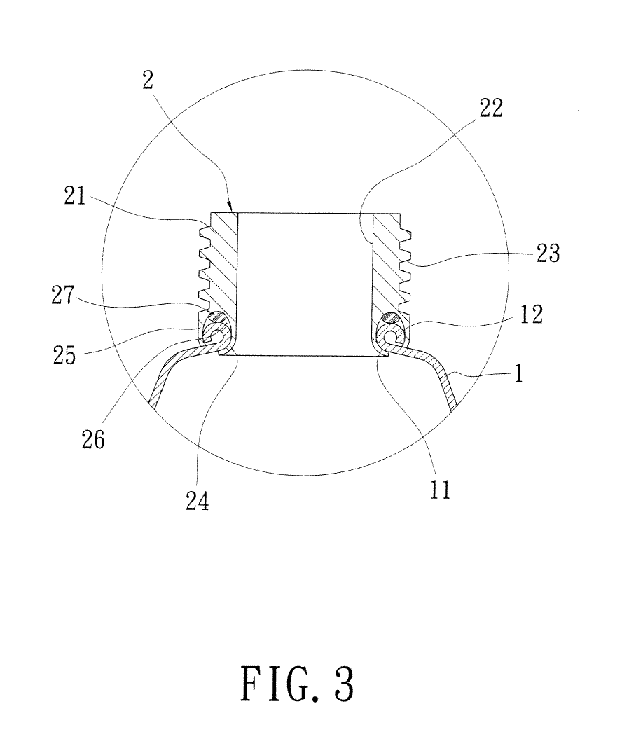

While being assembled, refer to FIG. 2 and FIG. 3, the inner clip 24 of the threaded sleeve 2 is set on an inner side of the bottle-top 11 of the cylinder 1 while the outer clip 25 is arranged at an outer side of the bottle-top 11. Thus the clip space 26 between the inner and the outer clips 24, 25 is clipped on the circular flange 12 of the bottle-top 11. Then a jig is resting against the inner and the outer clips 24, 25 of the threaded sleeve 2. A crossed spin-torsion is applied to the inner and the outer clips 24, 25 respectively through the jig so that the inner and the outer clips 24, 25 clip and cover the circular flange 12 on the bottle-top 11 of the cylinder 1. By the inner and the outer clips 24, 25 holding the circular flange 12 tightly, the threaded sleeve 2 is firmly fixed on and connected to the cylinder 1. Moreover, the gap between the threaded sleeve 2 and the bottle-top 11 of the cylinder 1 is significantly reduced due to the inner and the outer clips 24, 25 tightly covering the whole circular flange 12 of the bottle-top 11. Furthermore, the gap connected between the threaded sleeve 2 and the bottle-top 11 of the cylinder 1 is filled and blocked by the preset washer 27 mounted in the clip space 26 for preventing gas leakage.

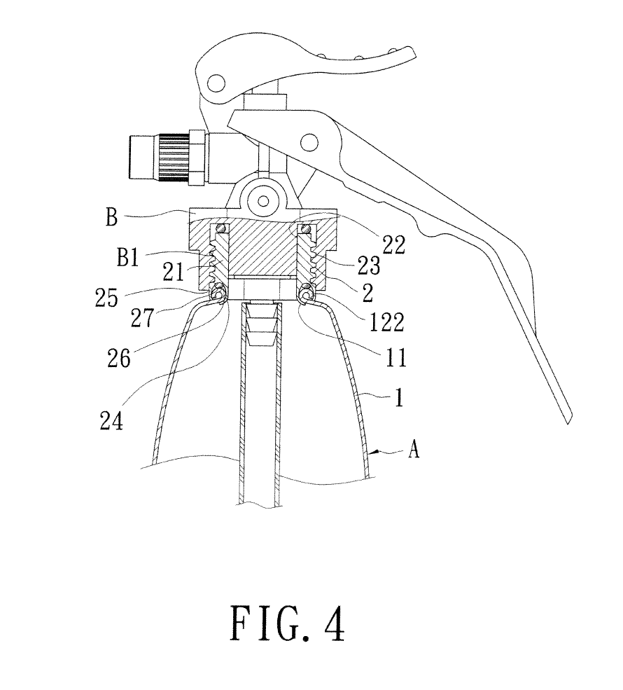

Refer to FIG. 4, when a nozzle (B) of fire extinguishers is connected and assembled with the safety cylinder (A), a threaded portion (B1) of the nozzle (B) is threaded with the threaded segment 23 of the threaded sleeve 2. By the threaded assembly, the nozzle (B) and the safety cylinder (A) are connected with each other easily and firmly. Moreover, under the protection of the threaded structure formed by layers, the gas leakage of the safety cylinder (A) is stopped and eliminated effectively.

The cylinder 1 of the safety cylinder (A) according to the present invention is made from metal with better malleability, ductility and hardness such as aluminum. Thus a thinner wall of the cylinder can have good pressure-bearing. Moreover, the manufacturing of the cylinder is easier and more convenient while the defect rate is also reduced. The manufacturing cost is dramatically reduced. Furthermore, the threaded sleeve 2 with turn threads is connected to the cylinder 1 so as to solve the problem of the thinner cylinder 1 that is unable to be threaded. The bottle-top 11 of the cylinder 1 is completely covered and held tightly by the inner and the outer clips 24, 25 clipped on the circular flange 12 of the bottle-top 11 of the cylinder 1. Together with the washer 27 filled the gap between the threaded sleeve 2 and the bottle-top 11 of the cylinder 1, the connection of the safety cylinder is as firm as an integrated piece and the gas leak prevention is achieved.

In addition, the nozzle (B) is arranged with a pressure gauge (B2). Thus users can learn the pressure inside the fire extinguisher through the changes of the value on the pressure gauge (B2) outside the fire extinguisher. If the pressure is low, have the extinguisher serviced or replaced so that the fire is put out as soon as possible while the fire burning.

In accordance with above embodiments and the structure, the present invention has following advantages:

1. A cylinder of a safety cylinder of the present invention is made from metal with thinner thickness and better hardness while a bottle-top is connected to a threaded sleeve with a certain thickness for turn threads so as to thread with a nozzle. Thus the safety cylinder with high pressure-bearing and low manufacturing cost is produced.
2. The connection between the threaded sleeve and the cylinder is arranged with an inner clip and an outer clip, both holding and covering a circular flange on the bottle-top of the cylinder tightly. A washer is filled in a gap between the threaded sleeve and the bottle-top of the cylinder. Thereby the connection of the safety cylinder is as firm as an integrated piece with the feature of leak proof.
3. The nozzle of the safety cylinder is set with a pressure gauge so that users can learn pressure inside a fire extinguisher through the value shown on the pressure gauge. When the pressure is low, the fire extinguisher should be replaced promptly in time so as to stop the fire effectively.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A safety cylinder comprising a cylinder of a fire extinguisher and a threaded sleeve assembled with a bottle-top of the cylinder; wherein
a circular flange is arranged at the bottle-top of the cylinder;
the threaded sleeve includes an assembly hole penetrating a sleeve body along a center of the sleeve body, a threaded segment formed on a wall of the sleeve body, an inner clip and a corresponding outer clip arranged around a bottom side of the sleeve body, and a clip space formed between the inner and the outer clips for holding and covering the circular flange on the bottle-top of the cylinder.

2. The device as claimed in claim 1, wherein a washer is mounted in the clip space of the threaded sleeve.

3. The device as claimed in claim 2, wherein the threaded segment of the threaded sleeve is formed on an outer surface of the wall of the sleeve body.

4. The device as claimed in claim 3, wherein a vertical length of the inner clip is longer than a vertical length of the outer clip.

5. The device as claimed in claim 4, wherein a thickness of the wall of the threaded sleeve is thicker than a thickness of the cylinder.

6. The device as claimed in claim 1, wherein the threaded segment of the threaded sleeve is formed on an outer surface of the wall of the sleeve body.

7. The device as claimed in claim 6, wherein a vertical length of the inner clip is longer than a vertical length of the outer clip.

8. The device as claimed in claim 1, wherein a vertical length of the inner clip is longer than a vertical length of the outer clip.

9. The device as claimed in claim 8, wherein a thickness of the wall of the threaded sleeve is thicker than a thickness of the cylinder.

10. The device as claimed in claim 1, wherein a thickness of the wall of the threaded sleeve is thicker than a thickness of the cylinder.
